(19) United States
(12) Patent Application Publication
(10) Pub. No.: US 2009/0245395 A1
(43) Pub. Date: Oct. 1, 2009

(54) TRANSMISSION CONTROL APPARATUS AND TRANSMISSION CONTROL METHOD

(75) Inventors: Isao SUZUKI, Kawasaki (JP); Masashige Kawarai, Kawasaki (JP); Masato Kobayashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/410,910

(22) Filed: Mar. 25, 2009

(30) Foreign Application Priority Data
Mar. 28, 2008 (JP) 2008-88182

(51) Int. Cl. H04B 3/00

(52) U.S. Cl. 375/257

(57) ABSTRACT

A transmission control apparatus detects worsening of an environmental condition of a transmission line for accommodating a plurality of circuits, and detects recovery of the environmental condition of the transmission line from the worsening. A first controller alters a transmission rate of data that is transmitted on the transmission line, from a first transmission rate to a second transmission rate, when the worsening of the environmental condition is detected, and which alters the transmission rate when the recovery of the environmental condition is detected. A second controller narrows down a bandwidth of a circuit of a lower priority when the bandwidth of any of the circuits having been accommodated by the transmission line becomes unaccommodatable because of the alteration of the transmission rate to the second transmission rate.

### CROSS-REFERENCE TO RELATED APPLICATIONS

This application is based upon and claims the benefit of priority of the prior Japanese Patent Application No. 2008-88182, filed on Mar. 28, 2008, the entire contents of which are incorporated herein by reference.

### BACKGROUND

1. Field

The embodiments discussed herein are related to a transmission control system which optimizes transmissions (BWB transmissions) based on wiring on a back wiring board within a transmission apparatus.

2. Description of the Related Art

In general, the network of a common carrier which provides an Internet connection service includes a metro/core network which stands between an access network for accommodating subscribers and an upper network service layer. A transmission apparatus such as ADM (Add Drop Multiplexer), WDM (Wavelength Division Multiplexing), or ROADM (Reconfigurable Optical ADM) is installed in the metro/core network. The transmission apparatus is large in an accommodatable transmission capacity, and it generally has an apparatus structure which is configured of the apparatus proper (a shelf) and PIUs (plug-in units) inserted therein. A back wiring board (BWB) is arranged deep in the shelf, and wiring lines for transmitting signals between the PIUs are formed on the BWB.

In the transmission apparatus of this sort, a design simulation is performed under the worst environmental condition (under a condition under which the material of a printed circuit board, and the characteristic values of transmission/reception devices, etc. are set at the worst values within allowable values), and a design is generally made so that the eye pattern of a received signal may not fall on the eye mask of the reception device (a transmission may become so-called error-free). This is because all circuits from which data are transmitted to the apparatus are premised to be high-quality (=error-free) circuits (for example, leased lines).

On the other hand, a higher rate/a larger capacity have been rapidly attained, and the transmission rates based on the wiring lines on the BWB within the transmission apparatus (“BWB transmissions” below) for use in the metro/core network have become 1 Gbps or above usually.

As a transmission rate becomes higher, a transmission loss increases more. Therefore, the limitation of a wiring length becomes shorter with the transmission rate. In case of a BWB transmission rate exceeding 1 Gbps, the limitation of the wiring length of the BWB transmission becomes, at most, about 1 m, and it forms a serious obstacle in designing the apparatus.

In a case, for example, where the members constituting the apparatus (the transmission/reception devices, the material of the printed circuit board, etc.) are determined beforehand, the maximum wiring length on the BWB is determined, and the number of the PIUs which are mountable under the limitation is limited. In some cases, therefore, the required transmission capacity cannot be satisfied.

Conversely, when the required transmission capacity/mounting aspect have been determined, a wiring length along which data must be transmitted is determined. In some cases, the members for transmitting the data in an error-free state over the distance cannot help being made expensive ones, and they cannot be realized.

The statement of a relevant technique is contained in Japanese Laid-open Patent Publication No. 2001-222474.

### SUMMARY

According to an aspect of the invention, a transmission control apparatus includes a first detection portion which detects worsening of an environmental condition of a transmission line for accommodating a plurality of circuits; a second detection portion which detects recovery of the environmental condition of the transmission line from the worsening; a first control portion which alters a transmission rate of data that is transmitted on the transmission line, from a first transmission rate to a second transmission rate, when the worsening of the environmental condition is detected, and which alters the transmission rate when the recovery of the environmental condition is detected; and a second control portion which narrows down a bandwidth of the circuit of lower priority degree when the bandwidth of any of the circuits having been accommodated by the transmission line till then becomes unaccommodatable on account of the alteration of the transmission rate to the second transmission rate.

Other aspects and advantages of the invention will be realized and attained by referring to the elements and combinations particularly described with reference to the accompanying drawings, wherein like numerals refer to like parts throughout, and forming a part hereof, and as pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating the configuration of a BWB transmission control system according to a first embodiment.

FIG. 2 is a flow chart illustrating an example of the operation of a rate switching decision portion in FIG. 1.

FIG. 3 is a flow chart illustrating an example of the operation of a traffic management controller.

FIG. 4 is a diagram illustrating the configuration of a BWB transmission control system according to a second embodiment.

FIG. 5 is a flow chart illustrating an example of the operation of a rate switching decision portion in FIG. 4.

FIG. 6 is a diagram illustrating the configuration of a BWB transmission control system according to a third embodiment.

FIG. 7 is a flow chart illustrating an example of the operation of a rate switching decision portion in FIG. 6.

### DESCRIPTION OF EMBODIMENT(S)

An office building in which a transmission apparatus is installed has its room temperature held constant, and transmission/reception devices, etc. having characteristics close to the worst values are not usually used. Hereinbelow, this environment shall be called the “ordinary environment” or “ordinary condition” as opposed to the “worst environment” or “worst condition” mentioned before. Besides, it shall be called the “worsening of an environmental condition” to change into an environment where a transmission error is relatively liable to develop, on account of the temperature rise or the like of any of the devices, and it shall be called the “recovery of the environmental condition” to recover into the original environment. In the ordinary environment as stated above, any transmission error does not usually develop even when a signal is transmitted at a wiring length (or transmission rate) exceeding a wiring length (or transmission rate) stipulated under the worst environment, though this is not absolutely guaranteed.

Besides, a service sort (for example, best effort service) which allows some bandwidth limit is included among service sorts which are provided by a common carrier, and a circuit (best effort circuit) which provides such a service is included among circuits which are accommodated in a BWB transmission line.

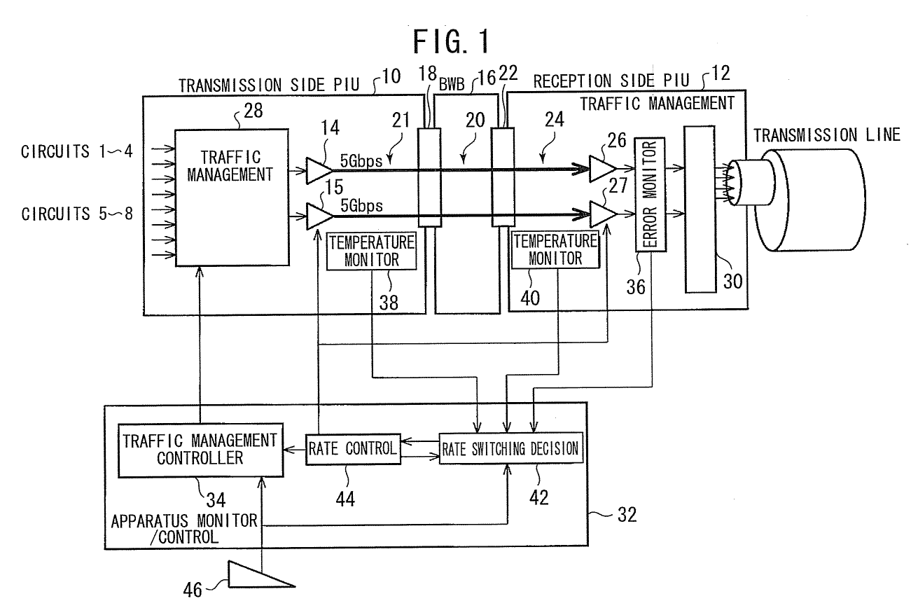

FIG. 1 shows the configuration of a BWB (back wiring board) transmission control system according to one embodiment. A large number of PIUs (plug-in units) are inserted in the shelf of the transmission apparatus, but only a transmission side PIU 10 and a reception side PIU 12 among them are shown in FIG. 1. A BWB 16 is arranged deep in the shelf. The transmission devices 14 and 15 for BWB transmissions are installed in the transmission side PIU 10, while the reception devices 26 and 27 are installed in the reception side PIU 12.

Data from the transmission side PIU 10 to the reception side PIU 12 proceeds from the transmission device 14 or 15 in the transmission side PIU 10, to the reception device 26 or 27, via a wiring line 21 in the transmission side PIU 10, a connector 18 connecting the transmission side PIU 10 and the BWB 16, a wiring line 20 in the BWB 16, a connector 22 connecting the BWB 16 and the reception side PIU 12, and a wiring line 24 in the reception side PIU 12. Although only two wiring lines are illustrated in the example shown in FIG. 1, several thousand of wiring lines are laid between the PIUs in the general transmission apparatus.

Traffic management portions 28 and 30 are respectively disposed in the transmission side PIU 10 and the reception side PIU 12. The traffic management portion 28 disposed in the transmission side PIU 10 sorts each packet into any of several service classes in accordance with set rules, with reference to user information contained in the header of the packet (or frame) and under the control of a traffic management controller 34 in an apparatus monitor/control unit 32, and it performs the control of an input bandwidth corresponding to a degree of priority, that is, the discard control and shaping, etc. of a packet on the basis of the service class. The traffic management portion 30 disposed in the reception side PIU 12 performs the discard control and shaping, etc. of the packet corresponding to the degree of priority of the packet.

An error monitor portion 36 is disposed in the reception side PIU 12. In a case where an MAC (Media Access Control) frame is transmitted in the section of the BWB 16, the error monitor portion 36 may detect any error by referring to the FCS (Frame Check Sequence) of the frame. In case of a SONET (Synchronous Optical NETwork) frame, error detection is possible by referring to the B1, B2 or B3 byte of an overhead. In case of a GFP-F (Frame-mapped Generic Framing Procedure) frame, the Core HEC field of a core header is referred to. Temperature monitor portions 38 and 40 are respectively disposed near the transmission devices 14 and 15 and near the reception devices 26 and 27, so as to measure the temperatures of the vicinities of the devices.

A rate switching decision portion 42 in the apparatus monitor/control unit 32 decides the switching of bit rates on the basis of the detection signal of the error monitor portion 36 and/or the temperatures of the vicinities of the devices as detected by the temperature monitor portions 38 and 40, and it commands a rate control portion 44 to switch the bit rates. An OpS (Operation System) unit 46 sets and alters the various set values of the apparatus monitor/control unit 32 through the inputs of an operator.

It is assumed that circuits 1-4 of low priority degree at a transmission rate (for example, bit rate) of 1 Gbps, and circuits 5-8 of high priority degree at a bit rate of 1 Gbps are accommodated in the system shown in FIG. 1. Besides, the length of the wiring lines between the transmission devices 14 and 15 and the reception devices 26 and 27 is assumed to be, at most, the maximum wiring length with which the transmissions become (can be maintained) so-called error-free under the ordinary condition when the bit rate of the transmissions between the transmission/reception devices is 5 Gbps, and it is assumed to be, at most, the maximum wiring length with which the transmissions become so-called error-free even under the worst condition when the transmission rate is 2.5 Gbps. Since the sum of the bit rates of the circuits 5-8 of the high priority degree is 4 Gbps, it is smaller than the total capacity of 5 Gbps at the time when both the bit rates of data which are transmitted on the two wiring lines have been altered to 2.5 Gbps.

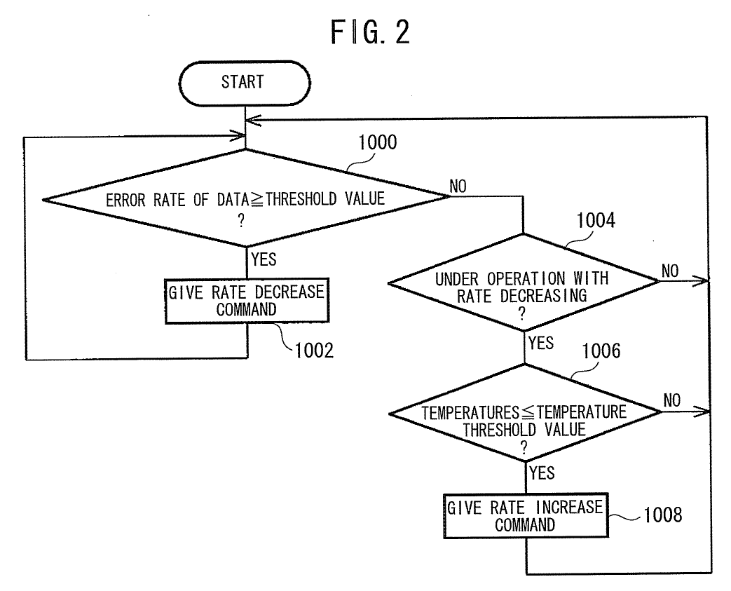

FIG. 2 is a flow chart showing an example of the operation of the rate switching decision portion 42 in FIG. 1. First, the error rate of data as detected by the error monitor portion 36 is compared with a certain threshold value (1000). If the detected error rate is equal to or greater than the threshold value, the decision portion 42 commands the rate control portion 44 to decrease the rate (1002). That rate control portion 44 in FIG. 1 which has received the rate decrease command conveys this command to the traffic management controller 34, and the rate control portion 44 directs the corresponding transmission device 14 or 15 and the corresponding reception device 26 or 27 to decrease the rates from 5 Gbps to 2.5 Gbps. Concretely, a multiplier unit (not shown) which generates, for example, the transmitting clock of the transmission device is commanded to alter the frequency of the clock, and the clock frequency of the transmission device is notified to the CDR (Clock Data Recovery) part (not shown) of the reception device. When the error rate is equal to or greater than the threshold value as to the reception device 26, the transmission device 14 and the reception device 26 are commanded to decrease the rates, and when the error rate is equal to or greater than the threshold value as to the reception device 27, the transmission device 15 and the reception device 27 are commanded to decrease the rates.

Referring back to FIG. 2, when the error rate is less than the threshold value (1000), the temperatures near the devices as have been detected by the temperature monitor portions 38 and 40 are compared with a certain temperature threshold value (1006) on a condition that the rate switching decision portion 42 is under the operation with the rate decreasing (1004). Here, when both the temperatures are equal to or less than the threshold value by way of example, the rate control portion 44 is commanded to increase the rates (1008). The rate control portion 44 which has received the rate increase command conveys this command to the traffic management controller 34, and the rate control portion 44 directs the corresponding transmission device 14 or 15 and the corresponding reception device 26 or 27 to increase the rates from 2.5 Gbps to 5 Gbps.

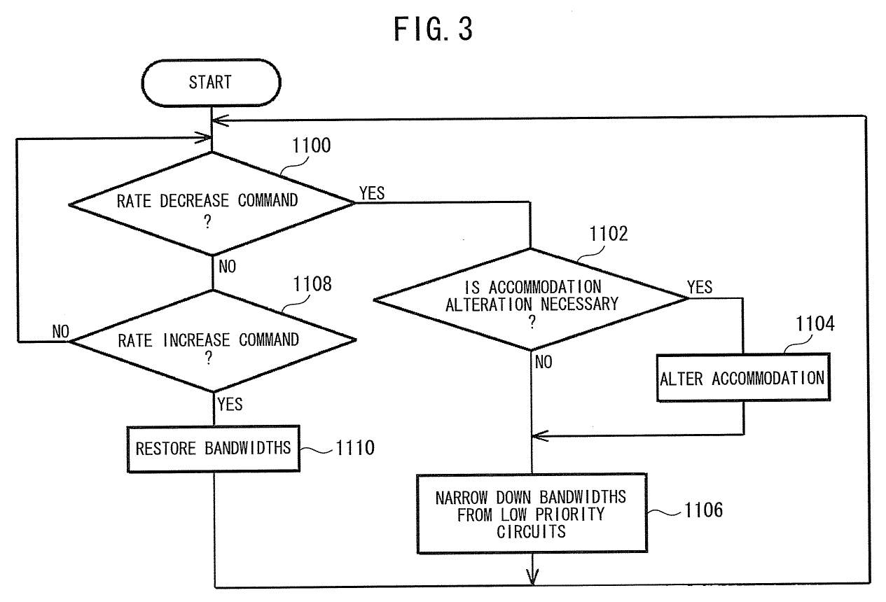

FIG. 3 is a flow chart showing an example of the operation of the traffic management controller 34 at the time when the rate decrease command or rate increase command has been received. Referring to FIG. 3, when the traffic management controller 34 has received the rate decrease command (1100), it first decides whether or not an accommodation alteration is necessary (1102). It is assumed by way of example that the low priority circuits 1 and 2 of 1 Gbps and the high priority circuits 5 and 6 of 1 Gbps are accommodated in the wiring line whose rate is to be decreased. In this case, when the total bandwidth of the low priority circuits 1 and 2 is narrowed down (lowered or decreased) to, at most, 0.5 Gbps even by performing the rate decrease to 2.5 Gbps, it becomes, at most, 2.5 Gbps, so that all the circuits are accommodatable, and the accommodation alteration is unnecessary. Besides, it is assumed by way of example that the high priority circuits 5-8 are accommodated in the wiring line whose rate is to be decreased. In this case, the bandwidths of the high priority circuits 5-8 cannot be narrowed down. On this occasion, when an accommodation alteration is performed between the high priority circuits 5-8 and any two circuits among the low priority circuits 1-4 accommodated in the other wiring line, the bandwidths may be narrowed down.

When it has been judged at the 1102 that the accommodation alteration is necessary, the traffic management controller 34 directs the traffic management portion 28 to alter the accommodation (1104), and it directs the traffic management portion 28 to narrow down the bandwidths of the low priority circuits (1106).

Meanwhile, when the traffic management controller 34 has received the rate increase command (1108), the traffic management controller 34 directs the traffic management portion 28 to restore the bandwidths narrowed down (1110).

The aforementioned threshold value of the error rate for detecting the worsening of the environmental condition may be set at, for example, a value below which the system may be deemed substantially error-free, and 10E-12 in terms of a BER (Bit Error Rate). Besides, the aforementioned threshold value of the temperatures for detecting the recovery of the environmental condition may be set at, for example, 40 to 50° C.

According to this embodiment, even when the length of a transmission line has been made a certain value greater than the maximum length determined under the worst environment, a transmission which is free from any error or which involves few errors is realized under the ordinary environment. Even under the assumption that the environmental condition has been worsened by any cause, the worsened condition is detected by, for example, the error rate or the changes of the temperatures of the transmission/reception devices, and the transmission rate is lowered, whereby a quality may be maintained. When any of the bandwidths of the circuits which the transmission line has accommodated till then fails to be accommodated on account of the lowering of the transmission rate, the bandwidths of the circuits of the lower priority degree are narrowed down, whereby the bandwidth and quality of the circuit of higher importance degree may be maintained.

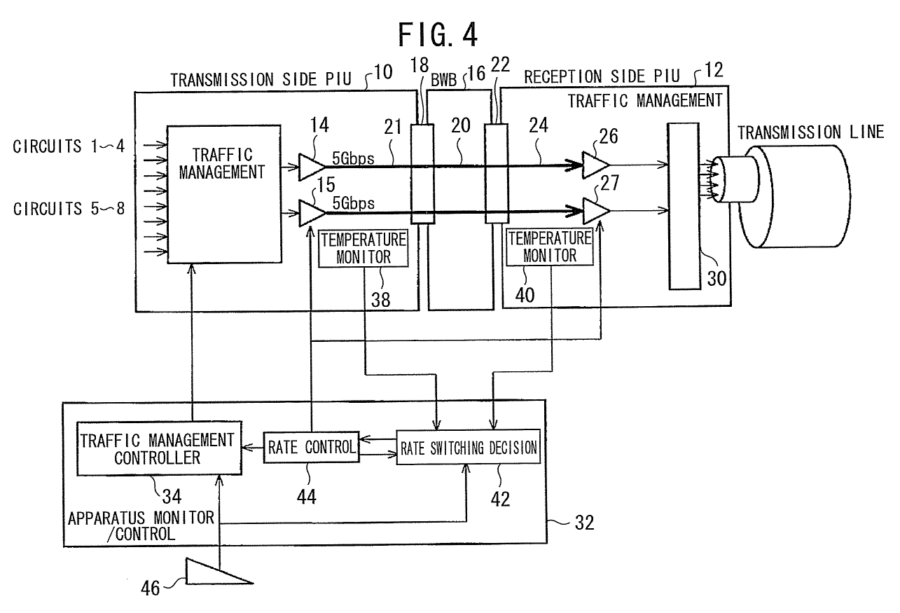

FIG. 4 shows the configuration of a BWB transmission control system according to the second embodiment. The point of difference of the second embodiment from the first embodiment described with reference to FIGS. 1 and 2 is that the worsening of the environmental condition is not detected by the error rates of data concerning the individual wiring lines, but that, not only the recovery of the environmental condition, but also the worsening thereof is detected by temperatures measured by the temperature monitor portions 38 and 40 which are respectively disposed near the transmission devices 14 and 15 and the reception devices 26 and 27.

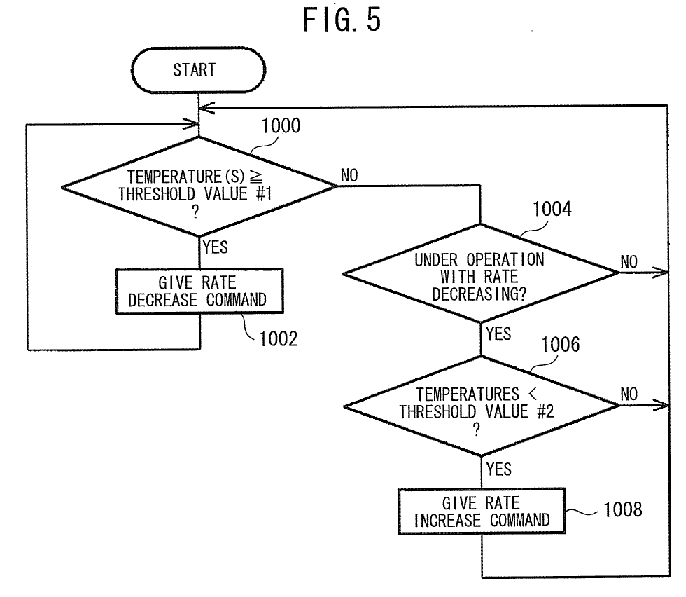

FIG. 5 is a flow chart showing an example of the operation of the rate switching decision portion 42 in the second embodiment. The point of difference of FIG. 5 from FIG. 2 is that a rate is decreased when, at 1000, at least one of the temperatures measured by the temperature monitor portions 38 and 40 is equal to or greater than a threshold value #1. The relationship between the threshold value #2 which is a temperature threshold value (1006) for deciding a rate increase can also be set at, for example, the threshold value #1>the threshold value #2, thereby to afford a hysteresis characteristic.

The operation of the traffic management controller 34 may be the same as in the first embodiment shown in FIG. 3. In decreasing the rates on account of the temperatures near the devices, however, the rates are switched from 5 Gbps to 2.5 Gbps for both the wiring lines, and hence, the total capacity is decreased from 10 Gbps to 5 Gbps. Accordingly, bandwidths are narrowed down so that the sum of the bandwidths of the low priority circuits 1 to 4 may become, at most, 1 Gbps. Besides, if necessary, an accommodation alteration is performed.

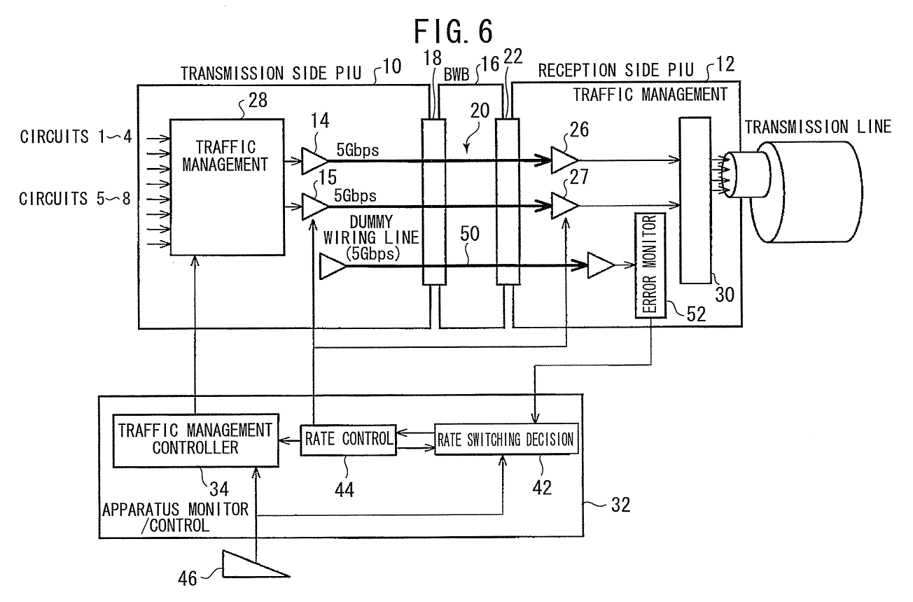

FIG. 6 shows the configuration of a BWB transmission control system according to the third embodiment. The point of difference of the third embodiment from the second embodiment described with reference to FIGS. 4 and 5 is that the worsening and recovery of the environmental condition are not detected by the temperatures measured by the temperature monitor portions 38 and 40, but that a dummy wiring line 50 is laid near the wiring lines 20, that a test signal is always caused to flow through the dummy wiring line 50, and that the worsening and recovery of the environmental condition are detected in accordance with an error detection result in an error monitor portion 52. The dummy wiring line 50 is endowed with the longest pattern as compared with the other actual wiring lines. The signal of, for example, PN (pseudo noise) pattern may be used as the test signal.

The rate of the test signal which is caused to flow through the dummy wiring line is set at 5 Gbps being equal to the bit rate of data in an ordinary mode, and it is maintained at 5 Gbps even when the bit rate of the data is decreased. In the first embodiment described before, any error of the data flowing through the wiring lines 21, 20 and 24 is detected. In the rate decreasing mode, therefore, the rate is decreased to one establishing the error-free state even under the worst condition. In this state, accordingly, the recovery into the ordinary state cannot be detected from the change of the error rate. In contrast, in the third embodiment, even when the bit rate of the data is decreased to a rate establishing the error-free state under the worst condition, the rate of the test signal is not decreased, and hence, the recovery into the ordinary state may be detected from the change of the error rate.

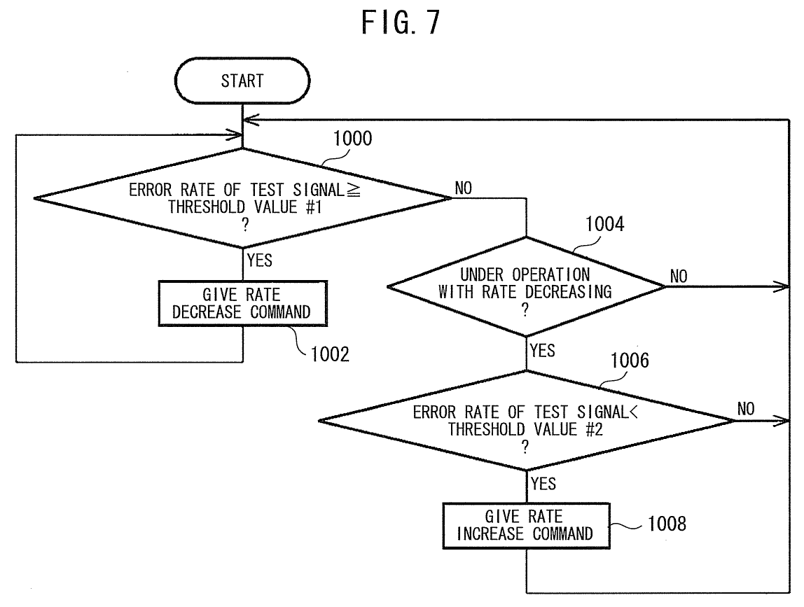

FIG. 7 is a flow chart showing an example of the operation of the rate switching decision portion 42 in the third embodiment. The point of difference of FIG. 7 from FIG. 5 is that, at 1000 and 1006, the error rates of the test signal flowing through the dummy wiring line 50 are compared with threshold values, instead of the temperatures near the devices, thereby to detect the worsening and recovery of the environmental condition. Both the threshold values #1 and #2 may be set at the aforementioned value (BER=10E-12) below which the error rate may be regarded as being substantially error-free. A hysteresis characteristic may well be afforded by setting the threshold value #1 >the threshold value #2.

According to an aspect of the embodiments of the invention, any combinations of the described features, functions, operations, and/or benefits can be provided. According to an aspect of an embodiment the transmission control apparatus 32 may be separate/independent from and communicably connectable to the transmission apparatus including the PIUs, or may be integrated with the PIUs or any combination thereof.

The embodiments can be implemented as an apparatus (a machine) that includes computing hardware (i.e., computing apparatus), such as (in a non-limiting example) any computer that can store, retrieve, process and/or output data and/or communicate (network) with other computers. According to an aspect of an embodiment, the described features, functions, operations, and/or benefits can be implemented by and/or use computing hardware and/or software. The apparatus (e.g., the PIUs 10, 12; apparatus monitor/control unit 32; etc.) comprises a controller (CPU) (e.g., a hardware logic circuitry based computer processor that processes or executes instructions, namely software/program), computer readable recording media, transmission communication media interface (network interface), and/or a display device, all in communication through a data communication bus. The results produced can be displayed on the display. A program/software implementing the embodiments may be recorded on computer computer-readable recording media. Examples of the computer-readable recording media include a magnetic recording apparatus, an optical disk, a magneto-optical disk, and/or semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc-Read Only Memory), and a CD-R (Recordable)/RW.

The program/software implementing the embodiments may also be included/encoded as a data signal and transmitted over transmission communication media. A data signal moves on transmission communication media, such as the wired network or the wireless network, for example, by being incorporated in a carrier wave. However, the data signal may be transferred not by the carrier wave described above but as a so-called baseband signal. Such a carrier wave is transmitted in an electrical, magnetic or electromagnetic form, or an optical, acoustic or any other form.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A transmission control apparatus comprising:
a computer processor to execute
a first detection portion which detects worsening of an environmental condition of a transmission line for accommodating a plurality of circuits;
a second detection portion which detects recovery of the environmental condition of the transmission line from the worsening;
a first control portion which alters a transmission rate of data that is transmitted on the transmission line, from a first transmission rate to a second transmission rate, when the worsening of the environmental condition is detected, and which alters the transmission rate when the recovery of the environmental condition is detected; and
a second control portion which narrows down a bandwidth of a circuit of a lower priority when a bandwidth of any of the circuits having been accommodated by the transmission line becomes unaccommodatable according to the alteration of the transmission rate to the second transmission rate.

2. The transmission control apparatus according to claim 1, wherein the first transmission rate is a transmission rate at which any error does not develop under an ordinary environment, and the second transmission rate is a transmission rate at which any error does not develop under a worst environment.

3. The transmission control apparatus according to claim 1, wherein said first detection portion detects the worsening of the environmental condition by comparing an error rate of the data which is transmitted on the transmission line, with a threshold value.

4. The transmission control apparatus according to claim 1, wherein said second detection portion detects the worsening of the environmental condition by comparing one or more of a temperature near a transmission device which transmits the data that is transmitted on the transmission line, a temperature near a reception device which receives the data, or any combinations thereof, with a threshold value.

5. The transmission control apparatus according to claim 1, wherein said first detection portion detects the worsening of the environmental condition by comparing an error rate of dummy data which flows through a dummy wiring line laid near the transmission line, with a threshold value.

6. The transmission control apparatus according to claim 1, wherein said second detection portion detects the recovery of the environmental condition by comparing one or more of a temperature near a transmission device which transmits the data that is transmitted on the transmission line, a temperature near a reception device which receives the data, or any combinations thereof, with a threshold value.

7. The transmission control apparatus according to claim 1, wherein said second detection portion detects the recovery of the environmental condition by comparing an error rate of dummy data which flows through a dummy wiring line laid near the transmission line, with a certain threshold value.

8. A transmission control method comprising:
detecting worsening of an environmental condition of a transmission line for accommodating a plurality of circuits;
detecting recovery of the environmental condition of the transmission line from the worsening;
altering a transmission rate of data that is transmitted on the transmission line, from a first transmission rate to a second transmission rate lower than the first transmission rate, when the worsening of the environmental condition is detected, altering the transmission rate from the second transmission rate to the first transmission rate when the recovery of the environmental condition is detected; and
narrowing down a bandwidth of the circuit of a lower priority when a bandwidth of any of the circuits having been accommodated by the transmission line becomes unaccommodatable due to the alteration of the transmission rate to the second transmission rate.

9. The transmission control method according to claim 8, wherein the first transmission rate is a transmission rate at which any error does not develop under an ordinary environment, and the second transmission rate is a transmission rate at which any error does not develop under a worst environment.

10. The transmission control apparatus according to claim 8, wherein the worsening of the environmental condition is detected by comparing an error rate of the data which is transmitted on the transmission line, with a certain threshold value.

11. The transmission control apparatus according to claim 8, wherein the worsening of the environmental condition is detected by comparing one or more of a temperature near a transmission device which transmits the data that is transmitted on the transmission line, a temperature near a reception device which receives the data, or any combinations thereof, with a threshold value.

12. The transmission control apparatus according to claim 8, wherein the worsening of the environmental condition is detected by comparing an error rate of dummy data which flows through a dummy wiring line laid near the transmission line, with a threshold value.

13. The transmission control apparatus according to claim 8, wherein the recovery of the environmental condition is detected by comparing one or more of a temperature near a transmission device which transmits the data that is transmitted on the transmission line, a temperature near a reception device which receives the data, or any combinations thereof, with a certain threshold value.

14. The transmission control apparatus according to claim 8, wherein the recovery of the environmental condition is detected by comparing an error rate of dummy data which flows through a dummy wiring line laid near the transmission line, with a certain threshold value.

15. A data transmission monitoring apparatus, comprising:
a computer processor to execute
detecting worsening of an environmental condition of a transmission line for accommodating a plurality of data circuits,
detecting recovery of the environmental condition of the transmission line from the worsening,
altering a transmission rate of data that is transmitted on the transmission line, from a first transmission rate to a second transmission rate, when the worsening of the environmental condition is detected, and altering the transmission rate when the recovery of the environmental condition is detected, and
lowering a bandwidth of a circuit of a lower priority when a bandwidth of any of the circuits having been accommodated by the transmission line becomes unaccommodatable due to the alteration of the transmission rate to the second transmission rate.
